(19) United States
(12) Patent Application Publication
(10) Pub. No.: US 2013/0013171 A1
(43) Pub. Date: Jan. 10, 2013

(54) AUTOMOTIVE FUEL SYSTEM

(75) Inventors: C. Joseph GHAFARI, Sterling Heights, MI (US); Roy MARTIN, North Royalton, OH (US)

(73) Assignee: FUEL CONCEPTS OF AMERICA, INC., Sterling Heights, MI (US)

(21) Appl. No.: 13/542,016

(22) Filed: Jul. 5, 2012

Related U.S. Application Data
(63) Continuation-in-part of application No. 13/178,891, filed on Jul. 8, 2011.

(51) Int. Cl. F02M 51/06; F02B 25/00; F02M 57/02; G06F 17/00

(52) U.S. Cl. 701/104; 123/478; 123/572; 123/446

(57) ABSTRACT

A PCV circuit for an internal combustion engine is modified to deliver the PCV fluid to an atomization chamber which also receives fuel from an electronic fuel injector tapped into the main vehicle fuel supply. The fuel from the injector is thoroughly vaporized in and/or immediately downstream of the chamber and conveyed to the vehicle intake manifold. In one embodiment, a switch cuts off operation of the fuel injector at high load/high throttle setting conditions. In another embodiment, injected fuel is measured with increased engine load. The injector operates at a constant frequency with a variable ON time.

### RELATED APPLICATION INFORMATION

This application is a continuation-in-part of application Ser. No. 13/178,891 filed Jul. 8, 2011 to which priority is claimed as to all common patentable subject matter.

### FIELD OF THE INVENTION

The invention relates to fuel systems and more particularly to a fuel system for an internal combustion engine (ICE) wherein the objective is to improve fuel economy.

### BACKGROUND OF THE INVENTION

Positive crankcase ventilation (PCV) circuits/systems and similar vacuum intake systems are in common use in gasoline burning internal combustion engines for automobiles in the United States and elsewhere. It is well known that the purpose and function of such systems is to collect blow-by from the engine crankcase and deliver it to the engine. In and of themselves, these systems do little or nothing to improve engine efficiency or fuel economy.

U.S. Pat. No. 7,117,859 discloses a system for metering fuel through a needle valve into fluid which is diverted from an automotive PCV circuit, and thoroughly vaporizing the fuel in one or more vaporization chambers before delivering the vaporized fuel/fluid mixture to the vehicle intake. It has been found that the end result of the use of this system is a surprising and significant increase in fuel economy.

### SUMMARY OF THE PRESENT INVENTION

An objective of the present invention is to provide pre-vaporized auxiliary fuel to an ICE during operation thereof. This may be achieved via connection of an auxiliary source to a PCV circuit or by auxiliary direct injection or by other means. As hereinafter described, we have found it advantageous to use electronic metering of fuel into the vaporization chamber.

A control circuit is provided to operate a fuel metering injector at a constant frequency but with an “on/off” time ratio which can be varied. In this way, the injected fuel quantity can be calibrated to engines of different displacements and fuel utilization rates. The control circuit is configured so as to be controlled by an external source such as the on-board diagnostic computer or a separate computer so as to set the duration of the “ON” time. Using suitably encrypted software, this makes it difficult for persons to tamper with the system.

For some engines, the control circuit may be actively controlled by engine operation data produced by a manifold absolute pressure (MAP) sensor or flow rate sensor or other source to vary the “ON” time of a fixed frequency cycle during which fuel is metered into the system.

In one embodiment of the system, particularly suitable for larger, e.g., 6 or 8 cylinder automotive engines, a switch provides a shutoff function under high load conditions. A pressure switch, for example, detects a high vacuum condition indicative of high load/full throttle engine operation. In this embodiment, a pressure switch shuts off the fuel metering device entirely, but resumes operation after the high vacuum condition abates. For other engine types, the high load, high rpm condition causes progressively more fuel to be metered into the vaporization chamber and the shut off function may be eliminated.

A second aspect of the invention hereinafter described is a method of operating an internal combustion engine of the type having a fluid circuit between the crankcase and the engine power-generation areas wherein the method comprises the steps of injecting fuel into the fluid flowing in the circuit, vaporizing the fuel in the fluid and delivering the vaporized fuel to the engine for consumption by the vehicle. This can be done by delivering the vaporization chamber fluid to an intake manifold, or by using another fuel delivery system such as a direct injection system having its own fuel lines connected to individual cylinders. We have found that the practice of this method causes the oxygen sensor of a conventionally equipped motor vehicle to signal the OEM fuel delivery system computer to reduce the primary fuel flow rate to return to the 14.7:1 ratio of air-to-fuel used in the operation of motor vehicle engines today. This leads to improved engine operation and a significant improvement in fuel economy.

We have also found it to be beneficial in all embodiments to heat the fuel entering or leaving the vaporization chamber. This can be done in various ways. Further, operation of the entire system is preferably delayed until the engine has reached a predetermined operating temperature.

In another embodiment of the invention, ideally suited as an OEM installation, the vaporization chamber output is delivered via multiple lines and injectors directly to the cylinder heads and combustion chambers. Moreover, the system senses engine load demand through, for example, a MAP sensor and increases the injection of the vaporized fluid either linearly with load or rpm or in discrete steps. In this embodiment, the cut-off switch may or may not be used.

The present invention has proved capable of providing surprising and substantial improvements in fuel economy for internal combustion engines of various kinds including not only those utilizing gasoline available at commercial stations but also other fuels such as ethanol, alcohol, blends of gasoline and ethanol and other bio-fuels. In addition, the invention can be used not only in conventional automobiles; but also in boats, trucks, SUV's, RV's, tractors, and other engine-driven devices.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying photographs, the latter being briefly described hereinafter. As used herein the term “PCV system” does not necessarily imply the presence of a PCV valve.

### BRIEF SUMMARY OF THE DRAWINGS

The description herein makes reference to the accompanying drawings wherein like reference numerals refer to like parts throughout the several views and wherein:

FIG. 1 is a block diagram of an internal combustion engine fuel system incorporating an embodiment of the present invention;

FIG. 2 illustrates a detail of one fuel injector control system which can be used in the system of FIG. 1;

FIG. 3 illustrates a detail of a second fuel injector control system which can be used in the system of FIG. 1;

FIG. 4 is a timing diagram indicative of a pulse duration variation/modulation system; and

FIG. 5 is an alternate system diagram with preheating, a delayed start-up and an auxiliary fuel delivery system.

### DETAILED DESCRIPTION OF THE ILLUSTRATIVE EMBODIMENT

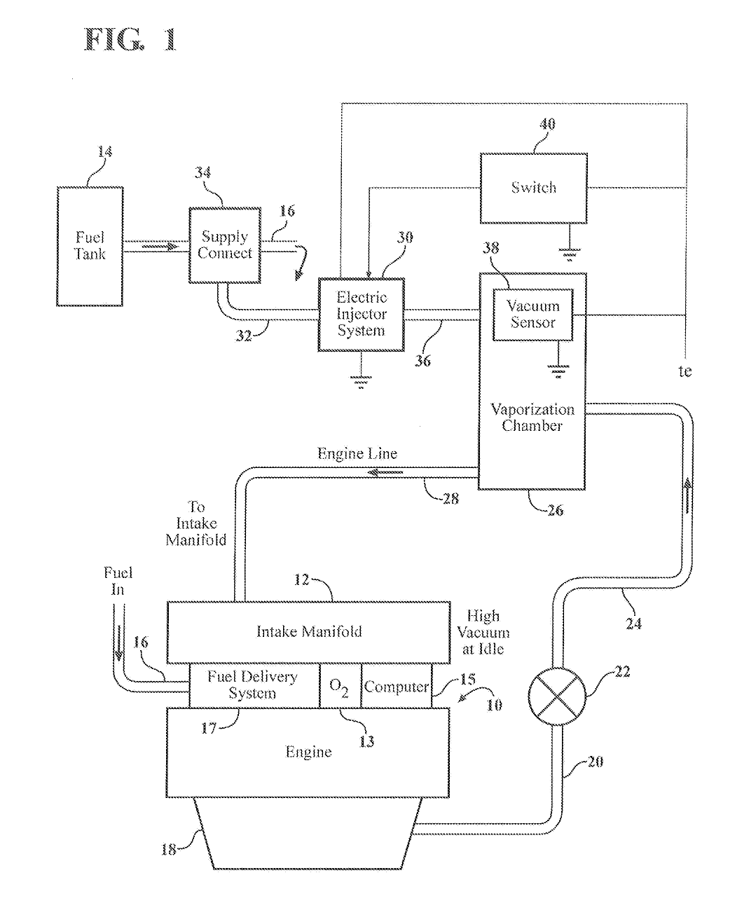

Referring now to FIG. 1, there is shown an internal combustion engine (ICE) 10 of the type having one or more pistons operating in cylinders (not shown) to produce power which can be used to propel an automotive vehicle or other ICE-powered device in conventional fashion. The engine 10 is equipped with an intake manifold 12, fuel source 14 in the form of a conventional fuel tank, the tank having a fuel supply line 16 which runs to a primary fuel delivery system 17 such as a carburetor or fuel injection system, and thence to the engine 10. It will be understood that the intake manifold 12 is used primarily to provide air to the engine 10 and that the fuel delivery system 17, particularly if it is of the fuel injection type, may be physically separate from the intake manifold but is in operative association therewith so that the injected fuel eventually is taken up into and distributed within the air which is delivered to the combustion chambers of the pistons and cylinders within the engine 10. The engine 10 is equipped with an O₂ sensor 13 and an on-board fuel computer 15 (OBD) which controls the air:fuel ratio via the fuel delivery system 17.

The engine 10 is also provided with a crankcase 18 which, in conventional fashion, provides a lubricant reservoir which typically splash-lubricates the crankshaft (not shown) of the engine 10. A positive crankcase ventilation (PCV) system shown here comprises a circuit 20 including a PCV valve 22 of conventional design connected between the crankcase 18 and the engine via the intake manifold 12. As stated above, not all PCV systems have the valve 22.

In accordance with the invention, the conduit 24 delivers the fluid in the PCV circuit 20 to a vaporization chamber 26 in the form of, for example, a stainless steel or fuel-safe plastic bottle, to input a hydrocarbon/air mixture of PCV fluid to the vaporization chamber 26. An output circuit 28 from the vaporization chamber runs from the bottom of the chamber 26 back to the intake manifold 12.

Mounted to and in operable association with the vaporization chamber 26 is an electronic fuel injector system 30 having a fuel supply line 32 which is tapped into the primary fuel delivery line 16 at a tap point 34. The injector system 30, which may be of the conventional piezoelectric injector type, operates to inject fuel into the vaporization chamber 26 at a high point so that such injected fuel can be thoroughly mixed into the fluid delivered to the chamber 26 by way of input line 24 and thoroughly vaporized within the chamber to the extent possible as well as downstream of the chamber in the line 28 as necessary. We have found that line 28 should be between about 30 and 145 inches in length to help in the vaporization process, the actual length depending on engine size and vacuum level.

The chamber 26 includes in operative association therewith a vacuum sensor 38 which is connected to supply a signal to a switch 40 which is electrically connected to the injector in the injector system 30 to shut the injector off at a predetermined pressure setting as sensed by the sensor 38. That setting is typically minus 5.7 in. Hg; however, the setting used in a given application may be higher or lower than −5.7 in. We place mesh screens in the vaporization chamber to enhance the process.

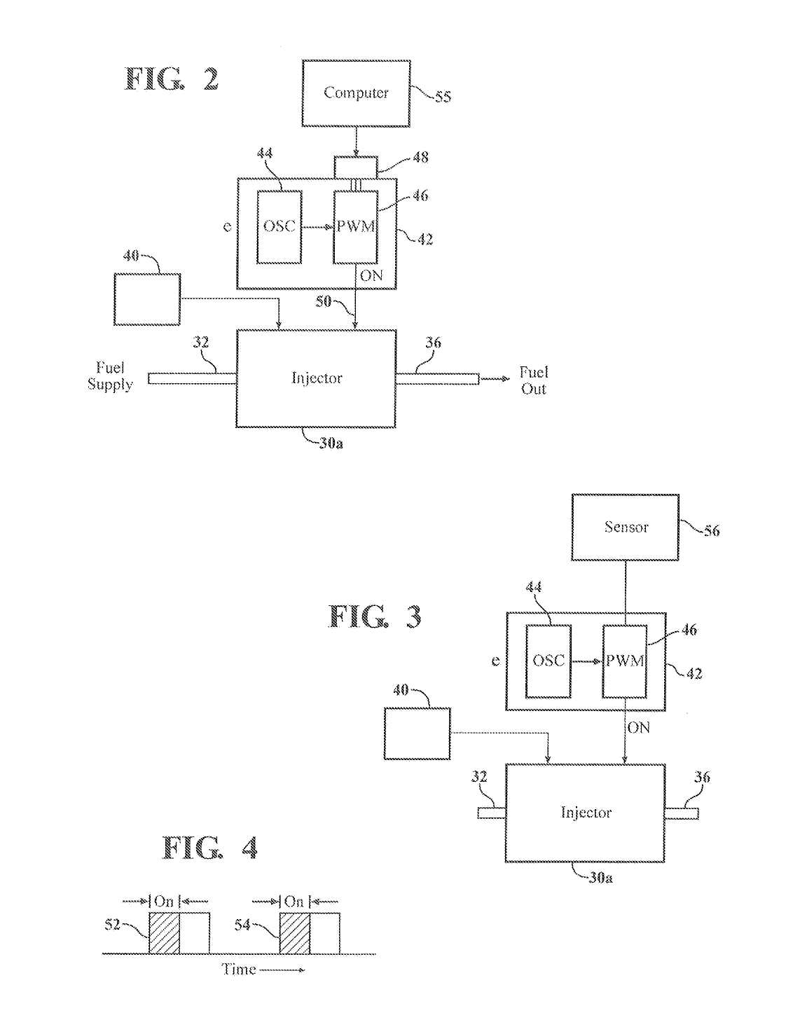

FIG. 2 shows the fuel injector system 30 in greater detail to include a piezoelectric injector 30A having a fuel supply line 32 and a fuel output line 36 as previously described. A control circuit 42, preferably in the form of a integrated circuit, comprises a fixed frequency source 44 connected to a suitably adjusted DC source, typically available in the vehicle containing the engine 10, as well as a pulse width modulation circuit 46. The pulse width modulation circuit 46 is capable of adjusting the ON time of the injector 30A in a manner generally indicated by the timing diagram of FIG. 4 wherein the frequency of the fixed frequency source 44 is based on the time interval between the leading edge of the left-hand pulse 52 and the leading edge of the right-hand pulse 54 in a set of two consecutive pulses. The ON time is represented by the shaded portion of each of the pulses and can be varied between minimum and maximum lengths or durations according to the output of the circuit 46.

The circuit 42 can be operated in either of the two different modes. In the first mode, a conventional USB computer port 48 is used to receive inputs from a digital computer 55 so as to set the circuit 46 to produce a fixed ON time or, to put it another way, a fixed ratio between the ON and OFF times of the fixed frequency injector 30A. This ON time setting is chosen in accordance with the displacement and/or horsepower range of the engine 10, smaller displacement engines having shorter ON times and larger displacement engines having longer ON times. As will be apparent to those skilled in the art, the shorter ON times of the injector 30A represent smaller quantities of fuel injected into the vaporization chamber 26 whereas longer ON times represent greater quantities of fuel injected into the vaporization chamber 26.

According to the second manner or mode of operation, the circuit 46 is connected to receive an input from a pressure sensor 56 mounted in association with the engine PCV circuit or otherwise to actively vary the ON time according to engine operating conditions.

Whichever mode or manner of operation is chosen, for 6 and 8 cylinder engines not using direct injection and for retrofit situations, the switch 40 is connected to the injector 40A to shut off all fuel injection into the vaporization chamber which forms part of the PCV diversion circuit during high load/high throttle setting conditions where the PCV circuit becomes essentially non-functional.

The invention works as described above; i.e., the fuel-rich mixture delivered from the vaporization chamber is detected by the O₂ sensor 13 as a departure from the 14.7:1 air-to-fuel ratio used by most manufacturers and signals the computer 15 to reduce fuel flow via the conventional fuel delivery system 17.

The invention can be supplied as a kit and used to retrofit existing vehicles or installed as OEM equipment.

A suitable device which satisfies the requirements of switch 40 is available from World Magnetics of Traverse City, Mich. and comprises a Teflon diaphragm in a polycarbonate case. The control circuit may be implemented as an Arduino nano U3.0 Gravitech-US circuit board having a Panasonic 1000 mA solid state relay with the ability to retrieve engine data. The port 48 may be a conventional multi-pin computer port such as a USB.

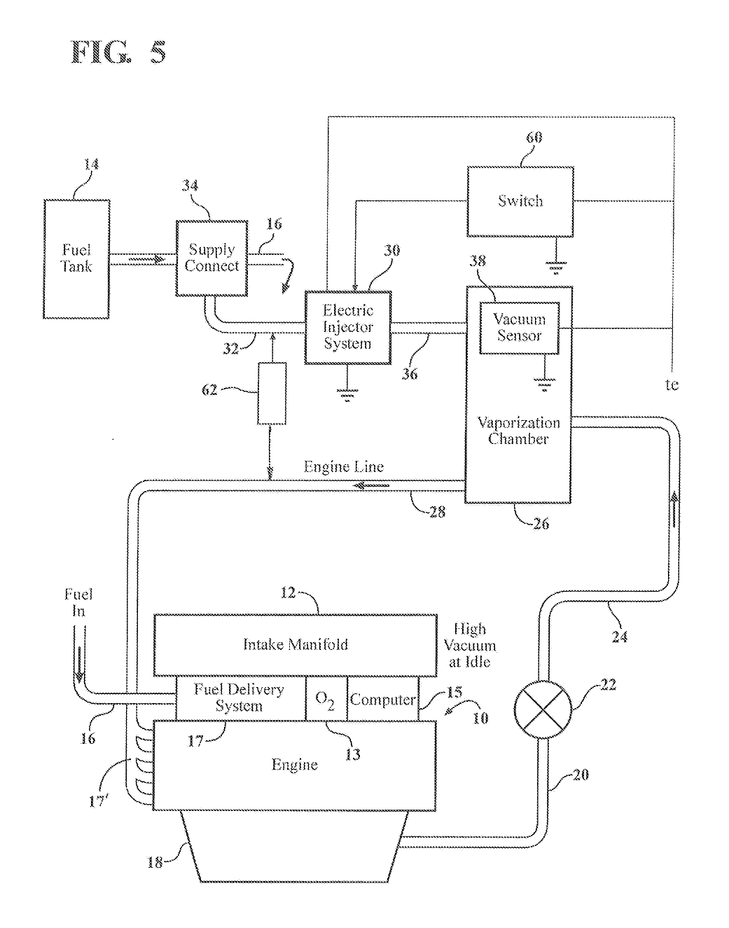

FIG. 5 shows an alternative embodiment with some features that can be added to the system of FIG. 1. In FIG. 5 a switch system 60 contains an engine temperature sensor and a throttle position or absolute manifold pressure sensor. The former disables the injector 30 until a normal or near-normal engine operating temperature is achieved. The latter lengthens the ON times of the injector cycles for higher load conditions either linearly or in steps. As indicated otherwise in this disclosure, engine load state or rpm can be sensed and represented by useful data signals by way of several devices including manifold pressure sensing, rpm sensing, throttle position and so on. The switch system 60 replaces switch 40 in FIG. 1, but it may be desirable to retain the cut-off switch for larger 6 or 8 cylinder engines for best fuel economy. A heater 62 is provided to pre-heat fuel prior to entering the vaporization chamber. The heater may alternatively be placed downstream of the vaporization chamber. The heat can be provided by a heating element or by running the fuel line next to an engine component.

FIG. 5 shows conduit 28 connected to engine 10 by way of an auxiliary fuel delivery system 17′. The system 17′ may be implemented as a direct injection system having its own multiple fuel delivery lines and injectors to the cylinder heads of the engine 10 as shown. In this case the OBD computer 15 is connected to delivery system 17′ as well to vary the relative amounts of (a) liquid fuel going to the engine from system 17 and (b) vaporized fuel going to the engine from the auxiliary system 17′. At some point, the engine 10 may run entirely on vaporized fuel from system 17′, e.g., when operating at a steady stable condition on “cruise control” at partial throttle. Although FIG. 5 effectively shows two fuel delivery systems, we deem it possible to have only one such system wherein the engine 10 runs entirely on fuel from the vaporization chamber. The preheat function and the delay function can also be used in the system of FIG. 1.

What is claimed is:

1. A fuel system for an internal combustion engine of the type comprising:
a fuel vaporization chamber;
an electronic fuel injector connected to meter fuel from a source into the vaporization chamber; and
the vaporization chamber being connected such that, when the engine is in operation, fluid from the vaporization chamber is delivered to the engine.

2. The system of claim 1 further including a pressure switch associated with the injector to stop operation thereof at a predetermined engine operating condition.

3. The system of claim 1 further including a control circuit associated with the injector to vary the quantity of fuel metered thereby.

4. The system of claim 3 wherein the control circuit is configured to cause the injector to operate at a constant frequency of on-off times.

5. The system of claim 3 wherein the ratio of on and off times is variable.

6. The system of claim 5 wherein the ratio is varied and set to a predetermined value by externally accessed programming.

7. The system of claim 5 wherein the ratio is actively varied by pressure conditions in the PCV circuit so as to vary the quantity of metered fuel.

8. The system of claim 1 wherein the vaporization chamber is connected to a PCV circuit and the vaporization chamber is connected to deliver fluid to the engine via an intake manifold.

9. The system of claim 1 wherein means are provided for sensing engine temperature and enabling operation of the electronic injector only after a predetermined engine temperature has been realized.

10. The system of claim 1 further including means for pre-heating fuel passing through the vaporization chamber.

11. An automotive power plant comprising:
an internal combustion engine having a crankcase;
a fuel source;
a vaporization chamber; and
the vaporization chamber having an output connected to a fuel delivery system feeding the engine.

12. The system of claim 11 further including a pressure switch associated with the injector to stop operation thereof at a predetermined engine operating condition.

13. The system of claim 11 further including a control circuit associated with the injector to establish the quantity of fuel metered thereby.

14. The system of claim 13 wherein the control circuit is configured to cause the injector to operate at a constant frequency of on-off times.

15. The system of claim 14 wherein the ratio of on and off times is variable.

16. The system of claim 15 wherein the ratio is actively varied by pressure conditions so as to vary the quantity of metered fuel.

17. The system of claim 10 further including means for enabling the fuel injector only after the engine has achieved a predetermined operating temperature.

18. A method of operating an internal combustion engine normally running on liquid fuel comprising the steps of:
metering liquid fuel into a vaporization chamber;
vaporizing the fuel metered into the vaporization chamber; and
variably conveying the vaporized fuel to the engine according to engine operating condition.

19. The method defined in claim 18 including the further step of varying the ratio of liquid fuel to vaporized fuel delivered to the engine according to engine operating condition.
